(19) United States
(12) Patent Application Publication
(10) Pub. No.: US 2026/0067819 A1
(43) Pub. Date: Mar. 5, 2026

(54) DEVICES, METHODS AND SYSTEM FOR CONTROLLING LOW-POWER WAKE UP SIGNAL MONITORING

(71) Applicant: HUAWEI TECHNOLOGIES CO., LTD., Shenzhen (CN)

(72) Inventors: Louis Madier, Boulogne Billancourt (FR); Yifan Xue, Beijing (CN)

(21) Appl. No.: 19/385,295

(22) Filed: Nov. 11, 2025

Related U.S. Application Data
(63) Continuation of application No. PCT/CN2023/093795, filed on May 12, 2023.

(51) Int. Cl. H04W 52/02; H04W 72/232

(52) U.S. Cl. CPC H04W 52/0235; H04W 72/232

(57) ABSTRACT

The present disclosure relates to low-power wake-up signalling for wireless communications. An apparatus is configured to monitor a first set of PDCCH candidates. In response to receiving a first signal indicating to start monitoring a LP-WUS, the apparatus is configured to monitor a second set of PDCCH candidates non-continuously, and monitor the LP-WUS simultaneously. In this way, latency-sensitive traffic can be fulfilled timely. In alternative to the first signal, the apparatus configured with CDRX can monitor the LP-WUS based on the active-inactive pattern of the CDRX. That is, the apparatus configured with CDRX is adapted to monitor the LP-WUS during inactive time of the CDRX, and not to monitor the LP-WUS during active time of the CDRX. In this way, latency-sensitive traffic can be fulfilled timely by flexibily adjusting the length of active time of the CDRX. Overall, traffic latency can be redueced and power consumption can be optimized.

### CROSS-REFERENCE TO RELATED APPLICATIONS

This application is a continuation of International Application No. PCT/CN2023/093795, filed on May 12, 2023, the disclosure of which is hereby incorporated by reference in its entirety.

### TECHNICAL FIELD

The present disclosure generally relates to the field of communications technology. For instance, the present disclosure provides devices, methods, and a system for controlling low-power wake up signal (LP-WUS) monitoring.

### BACKGROUND

Power consumption is critical for wireless communications, especially for wearable and Internet-of-Things (IOT) devices. For optimizing power consumption, the 3rd Generation Partnership Project (3GPP) in New Radio (NR) release 15 supports user equipment (UE) connected mode discontinuous reception (CDRX), where the UE periodically monitors physical downlink control channel (PDCCH) during active time of CDRX using monitoring pattern(s) defined by the network. In 3GPP NR release 16, downlink control information (DCI) with CRC scrambled by PS-RNTI (DCP) is introduced to further optimize power consumption. To this end, DCI format 2_6 is introduced, and the UE monitors DCP outside the active time of CDRX. 3GPP

NR standards release 17 supports scheduling DCI to indicate PDCCH skipping or search space set group (SSSG) switching. PDCCH skipping is used to indicate that the PDCCH is not monitored within a short period of time (i.e., skipping duration). SSSG switching indicates which SSSG should be used, such that the UE no longer needs to search the entire space.

For 3GPP NR release 18 and forward, a new mechanism called low-power wake-up signal (LP-WUS) is under study. When there is no traffic (as an example), a communications terminal may configure its main radio into sleep mode and power on its low-power wake-up receiver (LP-WUR). The LP-WUR consumes much less power than the main radio. The LP-WUS may be a dedicated signal designed to be detected by the LP-WUR, such that the communications terminal may be further configured to wake up its main radio for wireless (e.g., NR) communications. It is noted that the LP-WUS is different from the “WUS” indicated via DCI format 2_6. For instance, the LP-WUS is monitored by the LP-WUR, while the DCI format 2_6 is monitored by the main radio. Moreover, unlike the wake-up indication carried via DCI format 2_6, the LP-WUS may be transmitted via dedicated carrier(s) and/or using dedicated modulation.

### SUMMARY

It still remains a question as to how to integrate the LP-WUS mechanism with other power-saving techniques in 3GPP NR. For instance, if the LP-WUS mechanism is used in connected mode, it is still not clear how to start/stop/continue monitoring LP-WUS. Moreover, it is still not clear how the LP-WUS mechanism will affect or will be affected by other UE power saving techniques such as CDRX, DCP, PDCCH skipping, and SSSG skipping.

In view of the above-mentioned problems and disadvantages, the present disclosure aims to improve the LP-WUS mechanism. For instance, an objective may be to provide a solution to start, stop, and resume LP-WUS monitoring. A further objective may be to further optimize LP-WUS implementations such as LP-WUS monitoring coexistence with other power saving techniques.

These and other objectives are achieved by this disclosure, for instance, as described in the independent claims. Advantageous implementations are further described in the dependent claims.

A first aspect of the present disclosure provides an apparatus for wireless communications. The apparatus is configured to monitor a first set of PDCCH candidates. In response to receiving a first signal indicating to start monitoring a LP-WUS, the apparatus is configured to monitor a second set of PDCCH candidates non-continuously, and simultaneously monitor the LP-WUS.

Optionally, the apparatus may comprise a main radio and a LP-WUR. The LP-WUR may be adapted to monitor the LP-WUS. The main radio may be adapted to monitor the first set of PDCCH candidates (when the LP-WUS is not monitored by the LP-WUR), and monitor the second set of PDCCH candidates non-continuously (when the LP-WUS is monitored by the LP-WUR).

Optionally, the first set of PDCCH candidates may be monitored continuously or non-continuously.

Notably, the notion of “LP-WUS” may be referred to any LP-WUS that is detectable by the apparatus at any time during a LP-WUS monitoring period. The LP-WUS may be detectable on one or more dedicated carriers.

Optionally, the first signal may be sent by a network device. Alternatively, the first signal may correspond to a specific event or a met condition.

In this way, a minimum service can be guaranteed for the apparatus as a UE and may ensure a fast recovery. Moreover, traffic with low latency requirements can be fulfilled in a more reliable manner, e.g., through the second set of PDCCH candidates.

In an implementation form of the first aspect, after receiving the first signal, the apparatus may be configured to start monitoring the second set of PDCCH candidates non-continuously after a delay.

Optionally, the first signal may comprise a shift value indicating the delay. Alternatively, the value of the delay may be pre-configured.

In a further implementation form of the first aspect, a quantity of the second set of PDCCH candidates may be less than a quantity of the first set of PDCCH candidates.

In a further implementation form of the first aspect, the first set of PDCCH candidates may be monitored in a first search space. The second set of PDCCH candidates may be monitored in a second search space. The second search space may be smaller than the first search space.

In a further implementation form of the first aspect, the first set of PDCCH candidates may be monitored on a first active downlink bandwidth part (BWP). The second set of PDCCH candidates may be monitored on a second active downlink BWP. The first active downlink BWP may be different than the second active downlink BWP.

In a further implementation form of the first aspect, for monitoring the first set of PDCCH candidates, the apparatus may be configured to monitor a first number of DCI formats. For monitoring the second set of PDCCH candidates, the apparatus may be configured to monitor a second number of DCI formats. The second number of DCI formats may be less than the first number of DCI formats.

In a further implementation form of the first aspect, before receiving the first signal indicating to start monitoring the LP-WUS, the apparatus may be configured to receive configuration information of the LP-WUS.

Optionally, the configuration information may comprise information on one or more of:
a frequency carrier of the LP-WUS;
a bandwith of the LP-WUS;
modulation and coding scheme of the LP-WUS;
time resources/occasions where to monitor the LP-WUS;
spatial resources where to monitor LP-WUS (e.g., beams quasi co location (QCL) with the main radio beams); and the like.

In a further implementation form of the first aspect, in response to receiving a second signal indicating to stop monitoring the LP-WUS, the apparatus may be configured to:
stop monitoring the second set of PDCCH candidates;
stop monitoring the LP-WUS; and
monitoring the first set of PDCCH candidates.

The second signal may be received via the LP-WUS, or via one of the second set of PDCCH candidates.

In a further implementation form of the first aspect, the first signal may comprise DCI for notifying search space set group switching or PDCCH skipping.

Optionally, the DCI notifying search space set group switching may be referred to as DCI format 2 0.

A second aspect of the present disclosure provides an apparatus for wireless communications. The apparatus is configured with CDRX. The apparatus is configured to:
monitor a LP-WUS during inactive time of the CDRX; and
not monitor the LP-WUS during active time of the CDRX.

Optionally, the CDRX may comprise periodic CDRX cycles. Each CDRX cycle comprises active time and one inactive time. The LP-WUS is monitored during inactive time of each CDRX cycle. The LP-WUS is not monitored during active time of each CDRX cycle.

In this way, a network device (e.g., a base station (BS)) can be provided with a mechanism to reduce the scheduling latency for the apparatus as a UE. Power consumption of the apparatus can be optimized. Moreover, traffic with low-latency requirements can be fulfilled. For instance, the lengths of the active time, and/or the inactive time, and/or the length of the CDRX cycle may be flexibly adjusted with the coexistence of LP-WUS monitoring for fulfilling latency-sensitive traffics.

In an implementation form of the second aspect, the apparatus may be further configured to receive a first parameter indicating whether to wake up or not when the LP-WUS is not detected. When the first parameter is true and no LP-WUS is detected, the apparatus may be configured to switch to an active state in a CDRX cycle. Alternatively, when the first parameter is false and no LP-WUS is detected, the apparatus may be configured to keep monitoring the LP-WUS and not to switch to the active state in the CDRX cycle.

Optionally, the first parameter may be signaled via L3 control signaling, such as RRC signaling.

In a further implementation form of the second aspect, the apparatus may be configured to monitor a third set of PDCCH candidates during the active time of the CDRX. The apparatus may be configured to monitor a fourth set of PDCCH candidates in parallel with monitoring the LP-WUS.

In a further implementation form of the second aspect, the apparatus may be further configured to monitor DCI for notifying power saving information outside the active time of the CDRX; and receive a second parameter indicating whether to wake up or not, when the DCI for notifying power saving information is not detected. When the second parameter is true and the DCI for notifying power saving information is not detected, the apparatus may be configured to switch to the active state in the CDRX cycle. Alternatively, when the second parameter is false and the DCI for notifying power saving information is not detected, the apparatus may be configured to keep monitoring the LP-WUS and not to switch to the active state in the CDRX cycle.

Optionally, the DCI for notifying power saving information may be referred to as DCI format 2 6.

A third aspect of the present disclosure provides a method for wireless communications. The method comprises monitoring, by an apparatus, a first set of PDCCH candidates. In response to receiving, by the apparatus, a first signal indicating to start monitoring a LP-WUS, the method further comprises:
monitoring, by the apparatus, a second set of PDCCH candidates non-continuously; and
simultaneously monitoring, by the apparatus, the LP-WUS.

In an implementation form of the third aspect, the step of monitoring the second set of PDCCH candidates non-continuously may be started after a delay.

In a further implementation form of the third aspect, a quantity of the second set of PDCCH candidates may be less than a quantity of the first set of PDCCH candidates.

In a further implementation form of the third aspect, the first set of PDCCH candidates may be monitored in a first search space. The second set of PDCCH candidates may be monitored in a second search space. The second search space may be smaller than the first search space.

In a further implementation form of the third aspect, the first set of PDCCH candidates may be monitored on a first active downlink BWP. The second set of PDCCH candidates may be monitored on a second active downlink BWP. The first active downlink BWP may be different than the second active downlink BWP.

In a further implementation form of the third aspect, a first number of DCI formats may be monitored by the apparatus for monitoring the first set of PDCCH candidates. A second number of DCI formats may be monitored by the apparatus for monitoring the second set of PDCCH candidates. The second number of DCI formats may be less than the first number of DCI formats.

In a further implementation form of the third aspect, before receiving the first signal indicating to start monitoring the LP-WUS, the method may comprise receiving, by the apparatus, configuration information of the LP-WUS.

In a further implementation form of the third aspect, in response to receiving, by the apparatus, a second signal indicating to stop monitoring the LP-WUS, the method may comprise:
stop monitoring, by the apparatus, the second set of PDCCH candidates;
stop monitoring, by the apparatus, the LP-WUS; and
monitoring, by the apparatus, the first set of PDCCH candidates.

The second signal may be received by the apparatus via the LP-WUS, or via one of the second set of PDCCH candidates.

In a further implementation form of the third aspect, the first signal may comprise DCI for notifying search space set group switching or PDCCH skipping.

The method of the third aspect may share the same optional features and advantages as the apparatus of the first aspect or any implementation form thereof.

A fourth aspect of the present disclosure provides a method for wireless communications. The method comprises the following steps:
monitoring, by an apparatus configured with CDRX, a LP-WUS during inactive time of the CDRX; and
not monitoring, by the apparatus, the LP-WUS during active time of the CDRX.

In an implementation form of the fourth aspect, the method may further comprise receiving, by the apparatus, a first parameter indicating whether to wake up or not when the LP-WUS is not detected. When the first parameter is true and no LP-WUS is detected, the method may comprise switching, by the apparatus, to an active state in a CDRX cycle. Alternatively, when the first parameter is false and no LP-WUS is detected, the method may comprise keeping monitoring, by the apparatus, the LP-WUS; and not switching, by the apparatus, to the active state in the CDRX cycle.

In a further implementation form of the fourth aspect, the method may comprise monitoring, by the apparatus, a third set of PDCCH candidates during the active time of the CDRX. The method may comprise monitoring, by the apparatus, a fourth set of PDCCH candidates in parallel with monitoring the LP-WUS.

In a further implementation form of the fourth aspect, the method may comprise monitoring, by the apparatus, DCI for notifying power saving information outside the active time of the CDRX; and receiving, by the apparatus, a second parameter indicating whether to wake up or not, when the DCI for notifying power saving information is not detected. When the second parameter is true and the DCI for notifying power saving information is not detected, the method may comprise switching, by the apparatus, to the active state in the CDRX cycle. Alternatively, when the second parameter is false and the DCI for notifying power saving information is not detected, the method may comprise keeping monitoring, by the apparatus, the LP-WUS; and not switching, by the apparatus, to the active state in the CDRX cycle.

The method of the fourth aspect may share the same optional features and advantages as the apparatus of the second aspect or any implementation form thereof.

A fifth aspect of the present disclosure provides a system comprising one or more user devices. Each user device is according to the first aspect or any implementation form thereof, or according to the second aspect or any implementation form thereof. The system further comprises a network device. The network device is configured to send a first signal to the one or more user devices. The first signal indicates to start monitoring a LP-WUS.

A sixth aspect of the present disclosure provides a computer program comprising a program code for performing the method according to the third aspect or any of its implementation forms.

A seventh aspect of the present disclosure provides a computer program comprising a program code for performing the method according to the fourth aspect or any of its implementation forms.

An eighth aspect of the present disclosure provides a non-transitory storage medium storing executable program code which, when executed by a processor (or a chipset), causes the method according to the third aspect or any of its implementation forms to be performed.

A ninth aspect of the present disclosure provides a non-transitory storage medium storing executable program code which, when executed by a processor (or a chipset), causes the method according to the fourth aspect or any of its implementation forms to be performed.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of the present disclosure, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above-described aspects and implementation forms will be explained in the following description in relation to the enclosed drawings, in which

FIG. 1 shows an example of a PDCCH and LP-WUS monitoring pattern applied to an apparatus according to the present disclosure;

FIG. 2 shows an example of stopping LP-WUS monitoring according to the present disclosure;

FIG. 3A-3B show examples of monitoring patterns between LP-WUS and CDRX according to the present disclosure;

FIG. 4 shows a further example of a monitoring pattern between LP-WUS and CDRX according to the present disclosure;

FIG. 5 shows an example of a monitoring pattern between LP-WUS and DCP according to the present disclosure;

FIG. 6 shows an example of LP-WUS monitoring with PDCCH skipping or SSSG skipping according to the present disclosure;

FIG. 7 shows a diagram of a method according to the present disclosure;

FIG. 8 shows a diagram of a further method according to the present disclosure; and

FIG. 9 shows an example of an apparatus according to the present disclosure.

### DETAILED DESCRIPTION OF EMBODIMENTS

A list of key terms and their acronyms/abbreviations used in the present disclosure is given as follows: 3rd Generation Partnership Project—3GPP; Base Station—BS; Connected mode Discontinuous Reception—CDRX; Configured Grant—CG; Cyclic Redundancy Check—CRC; Downlink Control Information—DCI; DCI with CRC scrambled by PS-RNTI—DCP; Dynamic Grant—DG; Downlink—DL; Discontinuous Reception—DRX; Discontinuous Transmission—DTX; gNodeB—gNB; Hybrid Automatic Repeat Request—HARQ; Low Power Wake Up Signal—LP-WUS; Low Power Wake Up Receiver—LP-WUR; New Radio—NR; Modulation and Coding Scheme—MCS; Physical Downlink Control Channel—PDCCH; Physical Downlink Shared Channel—PDSCH; power saving—PS; Physical Random Access Channel—PRACH; Radio Network Temporary Identifier—RNTI; Cell RNTI—C-RNTI; Paging RNTI—P-RNTI; Power Saving RNTI—PS-RNTI; Quasi Co Location—QCL; Random Access—RA; Radio Resource Control—RRC; Search Space Set Group—SSSG; Semi-Persistent Scheduling—SPS; Scheduling Request—SR; Uplink Control Information—UCI; Uplink—UL; Ultra-Reliable Low Latency Communications—URLLC; User Equipment—UE.

The present disclosure provides improvements and/or modifications for implementing low power wake up signaling in wireless communications.

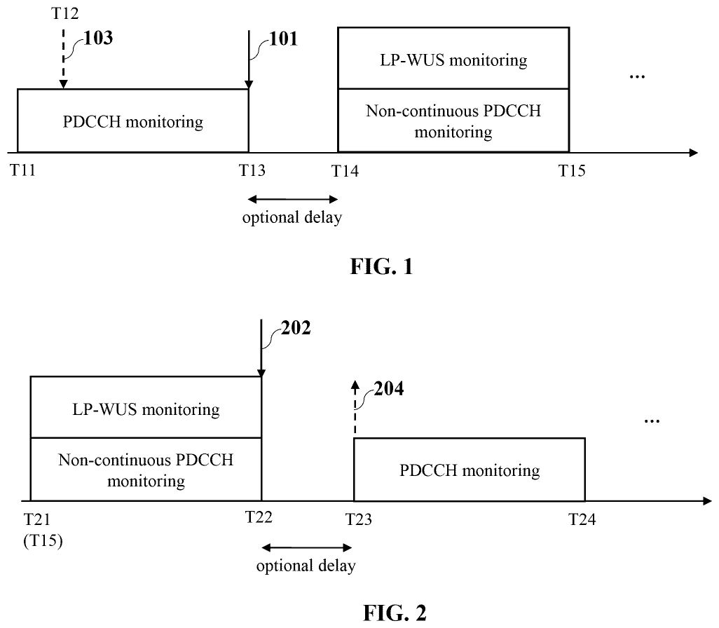

FIG. 1 shows an example of a PDCCH and LP-WUS monitoring pattern applied to an apparatus according to the present disclosure. During time point T11 and T15, the apparatus is not configured with energy saving features. For instance, the apparatus is not configured with any one of CDRX, DCP, PDCCH skipping, or SSSG skipping. Before starting LP-WUS monitoring, e.g., during T11 and T13, the apparatus is configured to monitor a first set of PDCCH candidates. The first set of PDCCH candidates may be monitored in a regular way, for instance, as defined in related 3GPP technical specifications (e.g., 3GPP TS 38.214). For instance, the apparatus may be configured to monitor the first set of PDCCH candidates in one or more CORESETs on active DL BWP on each activated serving cell configured with PDCCH monitoring according to corresponding search space sets, where monitoring may imply receiving each PDCCH candidate and/or decoding according to monitored DCI formats.

The apparatus is configured to receive (or obtain) a first signal 101, e.g., at time point T13 depicted in FIG. 1. The first signal 101 is indicative of starting monitoring a LP-WUS. In response to receiving the first signal 101, the apparatus is configured to monitor the LP-WUS, e.g., during time points T14 and T15 depicted in FIG. 1. At the same time when the apparatus is configured to monitor the LP-WUS, the apparatus is further configured to monitor a second set of PDCCH candidates non-continuously.

The apparatus in the present disclosure may be a user equipment (UE). The first signal 101 may be provided by a network device (e.g., a BS) to the apparatus. Alternatively, the first signal 101 may correspond to one or more met conditions (or events). For instance, if there is no active traffic for a certain period of time, the UE may consider that the first signal 101 is received and start LP-WUS monitoring. Generally speaking, the first signal 101 is used to activate LP-WUS monitoring and to activate the non-continuous PDCCH monitoring.

In this way, it can guarantee a minimum service for the UE and may ensure a fast recovery. For instance, if the LP-WUS is missed (e.g., the UE should have detected the LP-WUS but eventually did not successfully receive the LP-WUS during LP-WUS monitoring), the BS can still schedule transmission via the second set of PDCCH candidates.

For traffic with low latency requirements (e.g., extended reality (XR), URLLC, etc.), the BS can still use the second set of PDCCH candidates to quickly schedule transmission for the UE. This is because a PDCCH may be sent on 1-3 OFDM symbols with a possibility to schedule data on the same slot. However, for a LP-WUS, the number of needed OFDM symbols may be higher than 3 OFDM symbols with limited scheduling capability if any. Therefore, an example of an application scenario of the present disclosure may be: latency-sensitive traffic may be arranged via PDCCH (e.g., through the second set of PDCCH candidates), while traffic not sensitive to latency may be arranged via LP-WUS. The UE is configured to monitor the second set of PDCCH candidates and LP-WUS simultaneously.

Optionally, before receiving the first signal 101, the apparatus may be configured to receive configuration information 103 of the LP-WUS, e.g. at time point T12.

Optionally, there may be a delay between receiving the first signal 101 (e.g., time point T13) and starting the LP-WUS monitoring (e.g., time point T14). Optionally, the apparatus may be configured not to perform any PDCCH monitoring during the delay period (e.g., T13-T14). Alternatively, the apparatus may be configured to monitor the first set of PDCCH candidates during the delay period. Alternatively, the apparatus may be configured to monitor the second set of PDCCH candidates during the delay period.

Optionally, the number of PDCCH candidates in the second set of PDCCH candidates may be less than the first set of PDCCH candidates. Optionally, when monitoring the second set of PDCCH candidates, the apparatus may be configured to search less search space sets with fewer periodicities than monitoring the first set of PDCCH candidates. Optionally, the apparatus may be configured to change to a different DL BWP when monitoring the second set of PDCCH candidates. Optionally, when monitoring the second set of PDCCH candidates, the number of DCI formats to be monitored by the apparatus may be reduced.

FIG. 2 shows an example of stopping LP-WUS monitoring according to the present disclosure. The monitoring pattern in FIG. 2 may be built based on FIG. 1. For instance, time point T21 in FIG. 2 may correspond to time point T15 in FIG. 1.

During time points T21 and T22, the apparatus is configured to monitor LP-WUS and the second set of PDCCH candidates simultaneously as disclosed with respect to FIG. 1. At time point T22, the apparatus may be configured to receive a second signal 202 indicating to stop monitoring the LP-WUS. Accordingly, the apparatus is configured to stop monitoring the second set of PDCCH candidates, and stop monitoring the LP-WUS. The apparatus is configured to monitor the first set of PDCCH candidates, e.g., starting from time point T23. Optionally, the second signal 202 may be provided by the network device via the LP-WUS, or via PDCCH through the second set of PDCCH candidates.

Optionally, there may be a delay between receiving the second signal 202 (e.g., time point T22) and starting monitoring the first set of PDCCH candidates (e.g., time point T23). The delay may be pre-configured, or may be indicated by the first signal. Optionally, the first signal may comprise a shift value indicating the delay. Optionally, at time point T23 when the apparatus starts to monitor the first set of PDCCH candidates, the apparatus may be configured to send feedback information 204 to the network device. The feedback information 204 may be used to align monitoring status between the apparatus and the network device.

Features of FIG. 1 and FIG. 2 may be mutually combined. For instance, if a first signal is obtained by the apparatus at time point T24, corresponding features of FIG. 1 may be applied from time point T24.

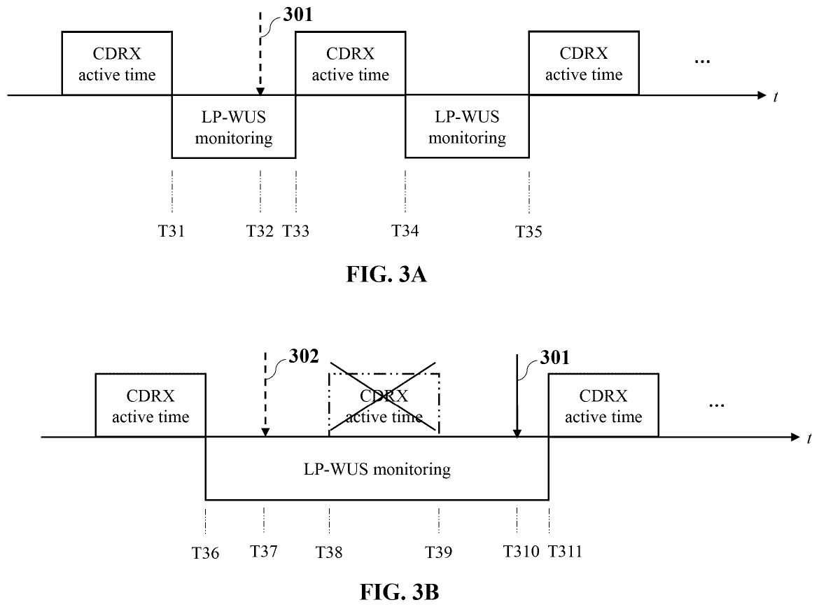

FIG. 3A shows an example of a monitoring pattern between LP-WUS and CDRX. In this example, the apparatus is configured with CDRX. When configured with CDRX, the apparatus is configured to periodically enter ‘sleep’ state (OFF or inactive duration/time of the CDRX). The apparatus is configured to wake up periodically and stay ‘awake’ (ON or active duration) for a certain amount of time before going to ‘sleep’ again. The length of the active/inactive duration may be controlled by parameters through L3 signaling (e.g., RRC signaling). For instance, the length of the active duration may be defined by an RRC parameter named “drx-OnDurationTimer”.

When CDRX is configured, there is no need to use a specific signal (e.g., the first signal in FIG. 1) to activate the LP-WUS monitoring. The apparatus may be configured to monitor the LP-WUS during inactive time of the CDRX, e.g., during T31 and T33, and during T34 and T35. That is, a mutual exclusive behavior between LP-WUS monitoring and CDRX may be adopted by the apparatus (e.g., as a default behavior): unless there is a specific command, when CDRX is in active time, then the LP-WUS monitoring is inactive; and when CDRX is in inactive time, then the LP-WUS monitoring is active.

Optionally, the apparatus may be configured to detect a LP-WUS 301, e.g., at time point T32 during a LP-WUS monitoring period. The detected LP-WUS 301 may be used to wake up the apparatus (e.g., by carrying a wakeup indication equal to “1”). Then, the apparatus may be configured to wake up: stop monitoring the LP-WUS and start CDRX active time, e.g., at time point T33. Optionally, there may be a delay between detecting the LP-WUS (time point T32) and starting the CDRX active time (time point T33).

Alternatively or additionally, when no LP-WUS is detected by the apparatus during a LP-WUS monitoring period T34-T35, but the apparatus is configured to wake up by default after a LP-WUS monitoring period (e.g., an RRC parameter “LP-μs-Wakeup” is equal to true), then the apparatus may also be configured to wake up when a LP-WUS monitoring period finished, e.g., at time point T35, and start CDRX active time. It is noted that the name of the RRC parameter controlling the default switching behavior is just given as an example. Other suitable names may be used.

FIG. 3B shows a further example of a monitoring pattern between LP-WUS and CDRX. As depicted in FIG. 3B, starting from time point T36, the apparatus switches from CDRX active to CDRX inactive, and starts monitoring the LP-WUS.

In this example, optionally, the apparatus may be configured to detect a LP-WUS 302, e.g., at time point T36 during a LP-WUS monitoring period. The detected LP-WUS 302 may be used to instruct the apparatus to keep sleeping (e.g., by carrying a wakeup indication equal to “0”). Then, the apparatus may be configured not to wake up. For instance, by not waking up, the next CDRX active time (e.g., from T38 to T39) may be skipped, and the apparatus is configured to keep monitoring the LP-WUS. At time point T310, the apparatus may be configured to detect a wake up signal like the LP-WUS 301 disclosed in FIG. 3A, and then wake up: stop monitoring the LP-WUS and start CDRX active time at time point T311.

In alternative to receiving the LP-WUS 302, when no LP-WUS is detected by the apparatus during a LP-WUS monitoring period, but the apparatus is configured to continue to sleep by default after a LP-WUS monitoring period (e.g., an RRC parameter “LP-μs-Wakeup” is equal to false), then the apparatus may also be configured to keep ‘sleeping’ when a LP-WUS monitoring period finished and no LP-WUS is detected. Then, the apparatus skips the next CDRX active time. It is noted that the name of the RRC parameter controlling the default switching behavior is just given as an example. Other suitable names may be used.

In general, when an apparatus configured with CDRX is doing LP-WUS monitoring, the apparatus may be configured to skip the next CDRX active time and continue LP-WUS monitoring (e.g., not activating drx-onDurationTimer) if:
LP-WUS is received with wake up indication=‘0’ (false); or
LP-WUS is not detected and LP-μs-Wakeup parameter=‘0’ (false).

The apparatus may be configured to start CDRX active time and stop LP-WUS monitoring (e.g., activating drx-onDurationTimer) if:
LP-WUS is received with wake up indication=‘1’ (true); or
LP-WUS is not detected and LP-Ps-Wakeup parameter=‘1’ (true).

In this way, the network side (e.g., a BS) can be provided with a mechanism to reduce the scheduling latency. Power consumption of the apparatus (e.g., a UE) can be saved. For example, in case of UE traffic with jitter, the gNB can shorten the length of the active time of a main radio of the UE. For example, in XR applications, a jitter of 8 ms could appear in DL which makes regular solutions to use OnDuration timer to be at least 8 ms. According to the present disclosure, the BS can configure a much smaller OnDuration timer (even less than the jitter value) and rely on LP-WUS monitoring to better handle the jitter issue.

Moreover, there is no need to add new timers for the operation of LP-WUS monitoring. There is also no need for LI signaling to activate/deactivate the LP-WUS monitoring. There is no impact/collision to the legacy CDRX behaviors for the UE.

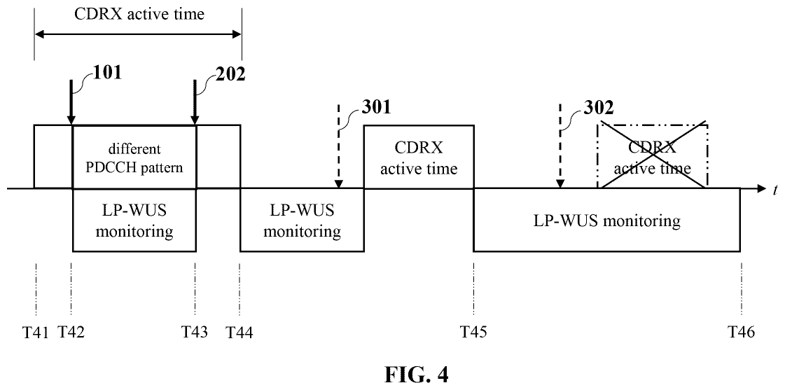

FIG. 4 shows a further example of a monitoring pattern between LP-WUS and CDRX. In this example, the mechanism of explicit signaling introduced in FIG. 1-2 can be combined with FIG. 3A-3B.

As depicted in FIG. 4, during a CDRX active time T41-T44 (e.g., at time point T42), the apparatus configured with CDRX may be configured to receive an activation signal during CDRX active time. The activation signal is similar to the first signal 101 introduced in FIG. 1 and is used to instruct the apparatus to start LP-WUS monitoring. Accordingly, the apparatus may be configured to start monitoring the LP-WUS (optionally, after a delay). At time point T43, the apparatus may be configured to receive a deactivation signal. The deactivation signal is similar to the second signal 202 introduced in FIG. 2. Accordingly, the apparatus may be configured to stop monitoring the LP-WUS (optionally, after a delay).

Similar to FIG. 1, during monitoring the LP-WUS, the apparatus may be configured to simultaneously monitor a different set of PDCCH candidates (in comparison to the PDCCH candidates monitored during CDRX active time). That is, during T41-T42, and during T43-T44, the apparatus may be configured to monitor a third set of PDCCH candidates. During T42-T43, the apparatus may be configured to monitor a fourth set of PDCCH candidates non-continuously. Simultaneously (during T42-T43), the apparatus may be configured to monitor the LP-WUS.

Optionally, the mutual exclusive behavior is introduced in FIG. 3A and FIG. 3B can be applied. For instance, the time period of T44-T45 may be based on the features in FIG. 3A; while the time period of T45-T46 may be based on the features in FIG. 3B.

Optionally, monitoring the third set of PDCCH candidates may share the same features of monitoring the first set of PDCCH candidates in FIG. 1; and monitoring the fourth set of PDCCH candidates may share the same features of monitoring the second set of PDCCH candidates in FIG. 1.

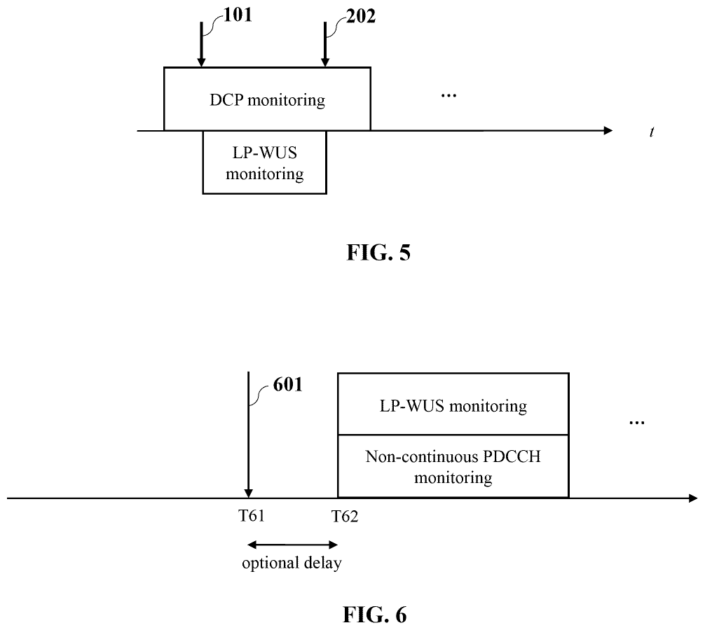

FIG. 5 shows an example of a monitoring pattern between LP-WUS and DCP. When the apparatus is configured to monitor DCP (e.g., DCI format 2_6), similar to FIG. 1 or FIG. 4, the apparatus may be configured to:
when LP-WUS is not monitored, monitoring a first set of PDCCH candidates for DCP;
when LP-WUS is monitored, simultaneously monitoring a second set of PDCCH candidates for DCP.

The first set of PDCCH candidates is different from the second set of PDCCH candidates. Optional features introduced in FIG. 1 with respect to the first set and the second set of PDCCH candidates may be similarly applied to the first set and the second set of PDCCH candidates in this example where DCP is configured.

In this way, monitoring the DCP can be used to check if LP-WUS is accurately delivering the wake-up indications. Moreover, it can enable the network device to define different default behaviors for the non-detection of LP-WUS and/or DCP. For example, RRC parameters of LP-Ps-Wakeup and DCP-Ps-Wakeup could be different. The parameter of DCP-Ps-Wakeup may be used to define the default behavior when DCP is not received when the UE monitor DCP before the next CDRX On duration. The parameter of LP-WUS LP-Ps-Wakeup may be used to define the default behavior when LP-WUS is not received when the UE monitors LP-WUS before the next CDRX On duration.

FIG. 6 shows an example of LP-WUS monitoring with PDCCH skipping or SSSG skipping. In this example, the command of PDCCH skipping or SSSG skipping could be used to trigger LP-WUS monitoring with or without PDCCH monitoring. That is, the first signal 101 in FIG. 1 may be a PDCCH skipping command or SSSG skipping command (e.g., DCI format 2_0).

During monitoring the LP-WUS, the apparatus may be configured to monitor PDCCH non-continuously, which is similar to monitoring the set of PDCCH candidates in FIG. 1.

In this example, the LP-WUS monitoring can be deactivated by one or more of the following signalings or conditions:
when a relevant timer of CDRX request the apparatus to switch to active time;
a specific deactivation signaling (e.g., the second signal 202) is received;
PDCCH skipping/SSSG skipping is finished.

It is noted that when the apparatus is configured with two or more of CDRX, DCP, PDCCH skipping, and SSSG skipping, corresponding features introduced with respect to FIG. 1-6 may be combined for implementing LP-WUS monitoring.

FIG. 7 shows a diagram of a method 700 according to the present disclosure. The method 700 is performed by an apparatus for wireless communications.

The method 700 comprises the following steps:
step 701: monitoring, by an apparatus, a first set of PDCCH candidates;
step 702: receiving, by the apparatus, a first signal indicating to start monitoring a LP-WUS;
step 703: in response to receiving the first signal, monitoring, by the apparatus, a second set of PDCCH candidates non-continuously; and
step 704: simultaneously monitoring, by the apparatus, the LP-WUS.

The steps of the method 700 may share the same functions and details from the perspective of the network device shown in the FIGS. 1-2 and 4-6 described above. Therefore, the corresponding method implementations are not described again at this point.

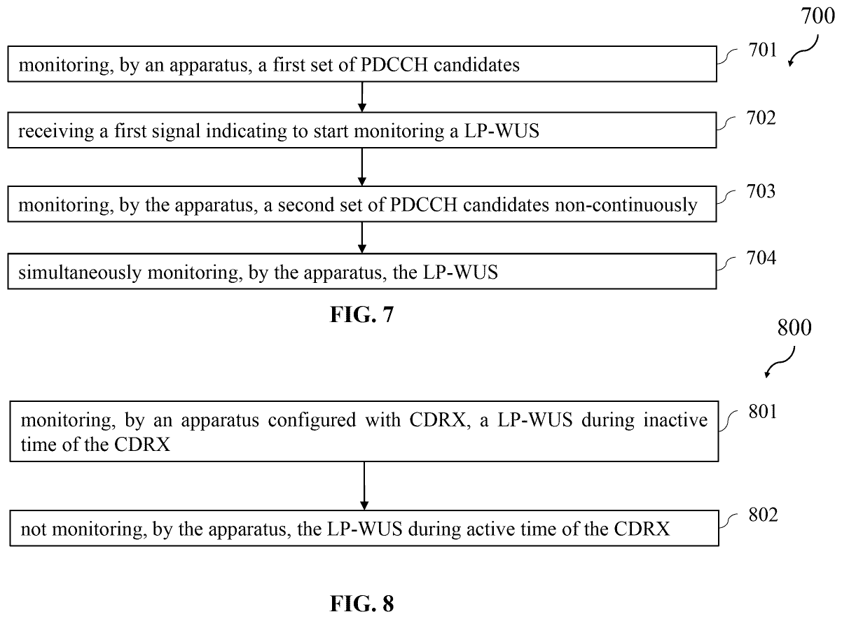

FIG. 8 shows a diagram of a further method 800 according to the present disclosure. The method 800 is performed by an apparatus for wireless communications.

The method 800 comprises the following steps:
step 801: monitoring, by an apparatus configured with CDRX, a LP-WUS during inactive time of the CDRX; and
step 802: not monitoring, by the apparatus, the LP-WUS during active time of the CDRX.

The steps of the method 800 may share the same functions and details from the perspective of the user device shown in the FIGS. 3A, 3B, and 4 described above. Therefore, the corresponding method implementations are not described again at this point.

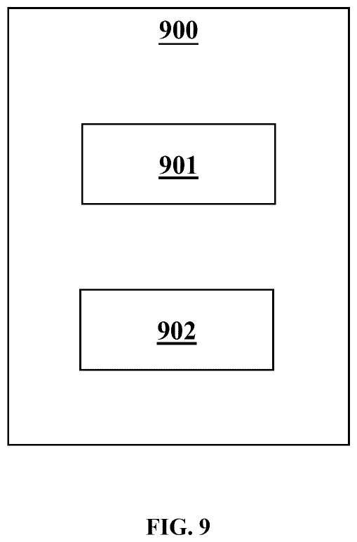

FIG. 9 shows an example of an apparatus 900 according to the present disclosure. The apparatus 900 is for wireless communications, such as but not limited to celluar communications (5G NR, 6G, etc.). The apparatus 900 comprises a low-power wake-up receiver (LP-WUR) 901 and a main radio 902. Other units (such as processing unit, storage unit) of the apparatus 900 are not depicted for the sake of simplicity. According to the present disclosure, the LP-WUR 901 is adapted to receive and monitor LP-WUS, e.g., on one or more first carriers. The main radio 902 is adapted to receive and transmit communications (e.g., NR) signals and channels (including performing PDCCH monitoring), e.g., on one or more second carriers. Optionally, the one or more first carriers and the one or more second carriers may be the same or different. Features of the apparatus 900 introduced in FIG. 9 may be applied to the apparatus introduced in FIGS. 1-6.

The present disclosure may be applied to any telecommunications networks/systems, such as but not limited to 5G (or NR), 6G mobile networks, and the like. The apparatus in this disclosure may comprise processing circuitry or a chipset (not shown) configured to respectively perform, conduct or initiate the various operations described herein. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. Optionally, the processing circuitry (or the chipset) comprises one or more processors and a non-transitory memory connected to the one or more processors. The non-transitory memory may carry executable program code which, when executed by the one or more processors, causes the apparatus to perform, conduct or initiate the operations or methods described herein.

The present invention has been described in conjunction with various embodiments as examples as well as implementations. However, other variations can be understood and effected by those persons skilled in the art and practicing the claimed invention, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. An apparatus (900) for wireless communications, comprising:
one or more processors in communications with a non-transitory memory storing computer instructions, wherein the instructions, when executed by the one or more processors, cause the apparatus to:
monitor a first set of physical downlink control channel (PDCCH) candidates;
in response to receiving a first signal (101) indicating to start monitoring a low-power wake-up signal (LP-WUS):
monitor a second set of PDCCH candidates non-continuously; and
simultaneously monitor the LP-WUS.

2. The apparatus (900) according to claim 1, wherein after receiving the first signal (101), the instructions, when executed by the one or more processors, cause the apparatus to start monitoring the second set of PDCCH candidates non-continuously after a delay.

3. The apparatus (900) according to claim 1, wherein a quantity of the second set of PDCCH candidates is less than a quantity of the first set of PDCCH candidates.

4. The apparatus (900) according to claim 1, wherein the first set of PDCCH candidates is monitored in a first search space, and the second set of PDCCH candidates is monitored in a second search space, wherein the second search space is smaller than the first search space.

5. The apparatus (900) according to claim 1, wherein the first set of PDCCH candidates is monitored on a first active downlink bandwidth part (BWP), and the second set of PDCCH candidates is monitored on a second active downlink BWP, wherein the first active downlink BWP is different than the second active downlink BWP.

6. The apparatus (900) according to claim 1, wherein for monitoring the first set of PDCCH candidates, the instructions, when executed by the one or more processors, cause the apparatus to monitor a first number of downlink control information (DCI) formats, and for monitoring the second set of PDCCH candidates, the instructions, when executed by the one or more processors, cause the apparatus to monitor a second number of DCI formats, wherein the second number of DCI formats is less than the first number of DCI formats.

7. The apparatus (900) according to claim 1, wherein before receiving the first signal (101) indicating to start monitoring the LP-WUS, the instructions, when executed by the one or more processors, cause the apparatus to receive configuration information (103) of the LP-WUS.

8. The apparatus (900) according to claim 1, wherein in response to receiving a second signal (202) indicating to stop monitoring the LP-WUS, the instructions, when executed by the one or more processors, cause the apparatus to:
stop monitoring the second set of PDCCH candidates;
stop monitoring the LP-WUS; and
monitor the first set of PDCCH candidates,
wherein the second signal (202) is received via the LP-WUS or via one of the second set of PDCCH candidates.

9. The apparatus (900) according to claim 1, wherein the first signal (103) comprises DCI for notifying search space set group switching, or DCI for notifying PDCCH skipping.

10. An apparatus (900) for wireless communications, configured with connected mode discontinuous reception (CDRX), comprising:
one or more processors in communications with a non-transitory memory storing computer instructions, wherein the instructions, when executed by the one or more processors, cause the apparatus to:
monitor a low-power wake-up signal (LP-WUS) during inactive time of the CDRX; and
not monitor the LP-WUS during active time of the CDRX.

11. The apparatus (900) according to claim 10, the instructions, when executed by the one or more processors, further cause the apparatus to:
receive a first parameter indicating whether to wake up or not when the LP-WUS is not detected;
when the first parameter is true and no LP-WUS is detected, the apparatus is configured to switch to an active state in a CDRX cycle; or
when the first parameter is false and no LP-WUS is detected, the apparatus is configured to keep monitoring the LP-WUS and not to switch to the active state in the CDRX cycle.

12. The apparatus (900) according to claim 10, wherein the instructions, when executed by the one or more processors, cause the apparatus to monitor a third set of physical downlink control channel (PDCCH) candidates during the active time of the CDRX, and the instructions, when executed by the one or more processors, cause the apparatus to monitor a fourth set of PDCCH candidates in parallel with monitoring the LP-WUS.

13. The apparatus (900) according to claim 10, wherein the instructions, when executed by the one or more processors, further cause the apparatus to:
monitor downlink control information, DCI, for notifying power saving information outside the active time of the CDRX;
receive a second parameter indicating whether to wake up or not when the DCI for notifying power saving information is not detected;
when the second parameter is true and the DCI for notifying power saving information is not detected, the apparatus is configured to switch to the active state in the CDRX cycle; or
when the second parameter is false and the DCI for notifying power saving information is not detected, the apparatus is configured to keep monitoring the LP-WUS and not to switch to the active state in the CDRX cycle.

14. A method (700) for wireless communications, the method comprising:
monitoring (701) a first set of physical downlink control channel, PDCCH, candidates;
in response to receiving (702) a first signal (101) indicating to start monitoring a low-power wake-up signal (LP-WUS):
monitoring (703) a second set of PDCCH candidates non-continuously; and
simultaneously monitoring (704) the LP-WUS.

15. The method (700) according to claim 14, wherein after receiving the first signal (101), the method (700) comprises: starting monitoring the second set of PDCCH candidates non-continuously after a delay.

16. The method (700) according to claim 14, wherein a quantity of the second set of PDCCH candidates is less than a quantity of the first set of PDCCH candidates.

17. The method (700) according to claim 14, wherein the first set of PDCCH candidates is monitored in a first search space, and the second set of PDCCH candidates is monitored in a second search space, wherein the second search space is smaller than the first search space.

18. The method (700) according to claim 14, wherein the first set of PDCCH candidates is monitored on a first active downlink bandwidth part (BWP), and the second set of PDCCH candidates is monitored on a second active downlink BWP, wherein the first active downlink BWP is different than the second active downlink BWP.

19. The method (700) according to claim 14, wherein for monitoring the first set of PDCCH candidates, the method (700) comprises: monitoring a first number of downlink control information, DCI, formats, and for monitoring the second set of PDCCH candidates, the method (700) comprises: monitoring a second number of DCI formats, wherein the second number of DCI formats is less than the first number of DCI formats.

20. The method (700) according to claim 14, wherein before receiving the first signal (101) indicating to start monitoring the LP-WUS, the method (700) comprises: receiving configuration information (103) of the LP-WUS.
